(19) United States
(12) Patent Application Publication
(10) Pub. No.: US 2017/0279777 A1
(43) Pub. Date: Sep. 28, 2017

(54) File signature system and method

(71) Applicants: Le Holdings (Beijing) Co., Ltd., Beijing (CN); LE SHI ZHI XIN ELETRONIC TECHNOLOGY (TIANJIN) LIMITED, Tianjin (CN)

(72) Inventors: Hanbin Luo, Tianjin (CN); Xiting Wang, Tianjin (CN)

(21) Appl. No.: 15/242,532

(22) Filed: Aug. 21, 2016

Related U.S. Application Data
(63) Continuation of application No. PCT/CN2016/089542, filed on Jul. 10, 2016.

(30) Foreign Application Priority Data
Mar. 28, 2016 (CN) 2016101831976

(51) Int. Cl. H04L 29/06; H04L 9/32; H04L 9/06

(52) U.S. Cl. CPC H04L 63/0428; H04L 9/0643; H04L 9/3242; H04L 9/3247

(57) ABSTRACT

Embodiments of the present disclosure relate to the field of data security, and a file signature system and method are disclosed. The system includes: an encryption server, configured to store an encryption key; and a signature client, configured to: generate an encrypted message according to a to-be-encrypted file, and send the generated encrypted message to the encryption server, where the encryption server is configured to: after receiving the encrypted message, generate a hash according to the encryption key, and send the hash back to the signature client; and the signature client is configured to sign the to-be-encrypted file according to the hash. By means of the foregoing solution, key exposure can be effectively avoided by storing an encryption key through an encryption server, thereby improving signature safety.

### CROSS-REFERENCE TO RELATED APPLICATIONS

The present disclosure is a continuation of PCT application No. PCT/CN2016/089542 submitted on Jul. 10, 2016, and the present disclosure claims priority to Chinese Patent Application No. 201610183197.6, filed on Mar. 28, 2016, and entitled “FILE SIGNATURE SYSTEM AND METHOD”, which is incorporated herein by reference in its entirety.

### TECHNICAL FIELD

The present disclosure relates to the field of data security, and specifically, to a file signature system and method.

### BACKGROUND

A series of security technologies are adopted to ensure security of data transmission, for example, an encryption technology, a digital signature, identity authentication, key management, a firewall, and a security protocol. The digital signature is one of core technologies that implement security of transaction online, which can ensure confidentiality of information transmission, integrity of data exchanges, non-repudiation of sending information, and certainty of identities of traders.

The digital signature is defined in the standard ISO7498-2 as: “some data that is added on a data unit, or a key change to the data unit, and such data and change are used for allowing a receiver of the data unit to determine a source of the data unit and integrity of the data unit and protecting data, so as to prevent from being forged by people (for example, the receiver)”.

The inventor finds during a process of implementing the present disclosure that a function implemented by the digital signature is an extension of a function implemented by a common handwritten signature. There are two main functions by signing on a written file: 1. because a person cannot deny his own signature, a fact that a file is signed by himself is determined; 2. because the signature signed by oneself is not easy to be imitated by others, a fact that the file is real is determined. These functions can be completed by using the digital signature:

(1) it is determined that a message is sent by a signer;

(2) it is determined that the message is not modified from singed to be received; and

(3) the signer cannot deny that the message is sent by himself.

A technical base of the digital signature is a Public Key cryptography. A set of digital signatures generally defines two complementary operations, one is used for signature, and another is used for validation. Only a sender of a message can generate a section of a digit string that cannot be forged by others, and the numeric string also effectively proves that the sender of the message truly sends the message.

The digital signature is a method for signing a message of an electronic form, and a signed message can be transmitted in a communications network. The digital signature can be obtained on the basis of a public-key cryptography system or a private-key cryptography system, and the former one is primary. The digital signature includes a common digital signature and a special digital signature. Algorithms of the common digital signature include an RSA digital signature algorithm, an ElGamal digital signature algorithm, a Fiat-Shamir digital signature algorithm, a Guillou-Quisquarter digital signature algorithm, a digital signature algorithm, an Ong-Schnorr-Shamir digital signature algorithm, Des/DSA, an Elliptic Curve Digital Signature Algorithm, a finite automation digital signature algorithm, and the like.

An identity of a signer can be verified by using the digital signature. However, in the prior art, a risk that code is acquired from an encrypted file by using an encryption rule still exists because an encryption and decryption manner in which a public-key is for encryption and a private key is for decryption is adopted, thereby reducing security of the encrypted file.

There is no good solution in the prior art for the foregoing problem.

### SUMMARY

An objective of this present application is to provide a method and a system. The method and the system provide a new file signature manner, thereby improving security of an encrypted file.

To achieve the foregoing objective, according to the first aspect, an embodiment of the present disclosure provides a file signature system, including:

an encryption server, configured to store an encryption key; and

a signature client, configured to: generate an encrypted message according to a to-be-encrypted file, and send the generated encrypted message to the encryption server, where

the encryption server is configured to: after receiving the encrypted message, generate a hash according to the encryption key, and send the hash back to the signature client; and

the signature client is configured to sign the to-be-encrypted file according to the hash.

According to the second aspect, an embodiment of the present disclosure further provides a file signature method, including:

generating an encrypted message according to a to-be-encrypted file;

sending the generated encrypted message to an encryption server;

after receiving the encrypted message, generating, by the encryption server, a hash according to an encryption key; and

signing the to-be-encrypted file according to the hash.

In an embodiment, the method further includes:

compiling the to-be-encrypted file to a binary file; and

generating the encrypted message according to the binary file.

According to the third aspect, an embodiment of the present disclosure further provides a non-volatile computer storage medium, which stores a computer executable instruction, where the computer executable instruction is used to execute any foregoing file signature method of this application.

According to the file signature system and method provided in embodiments of the present disclosure, key exposure can be effectively avoided by storing an encryption key through an encryption server, thereby improving signature safety.

Other features and advantages of the present disclosure are described in detail in the following part of specific embodiments.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a structural diagram of a file signature system according to an embodiment of the present disclosure;

FIG. 2 is a flowchart of a file signature method according to an embodiment of the present disclosure.; and

FIG. 3 is a schematic structural diagram of hardware of a device for executing a file signature method according to an embodiment of the present disclosure.

List of Reference Numerals

| | | | |
|---|---|---|---|
| 1 | Encryption server; | 2 | Signature client. |
| 310 | Processor | 320 | Memory |
| 330 | Input apparatus | 340 | Output apparatus |

### DETAILED DESCRIPTION

The following describes specific embodiments of this application in detail with reference to the accompanying drawings. It should be noted that the specific embodiments described herein are merely used for describing and explaining this application, and is not for limiting this application.

FIG. 1 is a structural diagram of a file signature system according to an embodiment of this application. As shown in FIG. 1, this application provides a file signature system, and the system may include:

an encryption server 1, to configure an storing encryption key; and

a signature client 2, configured to: generate an encrypted message according to a to-be-encrypted file, and send the generated encrypted message to the encryption server 1, where

the encryption server 1 is configured to: after receiving the encrypted message, generate a hash according to the encryption key, and send the hash back to the signature client 2; and

the signature client 2 is configured to sign the to-be-encrypted file according to the hash.

By means of the foregoing solution, key exposure can be effectively avoided by storing an encryption key through an encryption server, thereby improving signature safety.

A person skilled in the art can understand that a role of the encryption server is to store an encryption key and generate a hash according to the encryption key. The encryption server needs to have functions of storing and processing an operation to implement the foregoing role. In an embodiment, components of the encryption server may include a processor, a hard disk, a memory, a system bus, and the like, which is similar to a general computer architecture. However, because a reliable highly service needs to be provided, highly requirements on processing capacity, stability, reliability, security, expandability, manageability, and the like are.

In an embodiment, the signature client may be a signature client program, or a terminal or mobile terminal installed with a signature application. Examples of such terminal include but are not limited to a personal computer, a cell phone, a tablet computer, a personal digital assistant (PDA), or the like.

In an embodiment, the signature client may be configured to: compile the to-be-encrypted file to a binary file, and generate the encrypted message according to the binary file. In such an embodiment, the signature client is required to have a compiling capacity, that is, being capable of translating a program written with a given program design language to a program written with another equivalent language. Compiling is to convert a high level language into a binary language that can be recognized by a computer. The computer can merely recognize 1 and 0, and a compiling program converts a language that people are familiar with into the binary language. A working process in which the compiling program translates a source program to a target program is divided into five stages: lexical analysis, syntax analysis, semantic checking and intermediate code generation, code optimization, and target code generation. The lexical analysis and the syntax analysis are mainly processed, which are also referred to as source program analysis. An prompt message is offered when a syntax error is found during an analysis process.

A compiled language is a programming language that is implemented by a compiler. The compiled language is not like an interpreted language that is implemented by running code sentence by sentence through an literal translation, but compiling the code to machine code through the compiler, then running the machine code. Theoretically, any programming languages can be compiled or interpreted. A difference between the compiled programming language and the literal translation language is merely related to applications of programs.

In an embodiment, the encrypted message is generated according to the binary file, where the encrypted message may be a message digest of the binary file, for example, MDS code.

In an embodiment, the MD5 code used for ensuring integrity and consistency of message transmission is one of hash algorithms widely used by a computer (also referred to as a digest algorithm), and mainstream programming languages are generally implemented by the MD5 code. Operating data (for example, a Chinese character) to another fixed-length value is a basic principle of the hash algorithm, and predecessors of the MD5 are MD2, MD3, and MD4.

The MD5 algorithm has the following features:

1. compressibility: a length of a calculated MD5 value of data having an arbitrary length is fixed;

2. easy to calculate: it is very easy to calculate a MD5 value from primary data;

3. modification resistance: an obtained MD5 value is greatly different by modifying primary data, even if only one byte; and

4. powerful collision resistance: it is very difficult to find data having a same MD5 value (that is, forged data) if primary data and the MD5 value of the primary data is known.

A role of the MD5 is to compress a message having a large capacity into a confidential format before the message having a large capacity signs a private key by using digital signature software (that is, converting a byte string having a random length into a hexadecimal digit string having a given length).

In an embodiment, the signature client may further be configured to add the hash at the end of the to-be-encrypted file, so as to sign the to-be-encrypted file. The to-be-encrypted file in this embodiment is a binary code form, and content of the hash (for example, hash code) can be directly added at the end of the binary code, so as to sign the to-be-encrypted file.

In an embodiment, the encryption server 1l can be in communication with the signature client 2 through a network (for example, a wired network or a wireless network) through an application programming interface API. The API is some pre-defined functions whose objective is to provide an application program and a developer with a capability of accessing a group of routines based on given software or hardware without accessing source code or understanding details of an internal working mechanism.

The API mainly has two types:

Windows API

The API function is included in a dynamic link library file in a Windows system catalogue. The Windows API is a set of pre-defined Windows functions used for controlling an appearance and a behavior of each component of the Windows. Each behavior of a user may trigger running of one or several functions to tell the Windows what happened. This is like natural code of the Windows to some extent. Another language merely provides an automatic and easier method for accessing the API. When you click a button on a form, the Windows may send a message to the form, and a VB acquires the message to call and generates a particular event after analyzing.

For convenience of understanding, it is described that the Windows system coordinates an execution of the application program, an allocation of memory, and a management of system resources. Besides, the Windows system is a very large service center. Calling each service of the service center (each service is a function) can help the application program implement objectives of opening a window, describing a figure, using a surrounding device, and the like. Because an object that is served by these functions is the application program, these functions are referred to as Application Programming Interface, and API function is for short. An WIN32 API is an application programming interface of a Microsoft Windows 32 platform.

All application programs that are executed under a Windows working environment can call the Windows API.

Linux API

In a linux, a user programming interface API adheres to an application programming interface standard that is most popular in the UNIX, that is, the POSIX standard. The POSIX standard is a standard system developed by the IEEE and the ISO/IEC together. The standard describes a system calling programming interface API of an operation system on the basis of an existing UNIX practice and experience, which is used for ensuring that the application program can port and run on a source program level and on multiple operation systems. These system calling programming interfaces are implemented through a C library (LIBC).

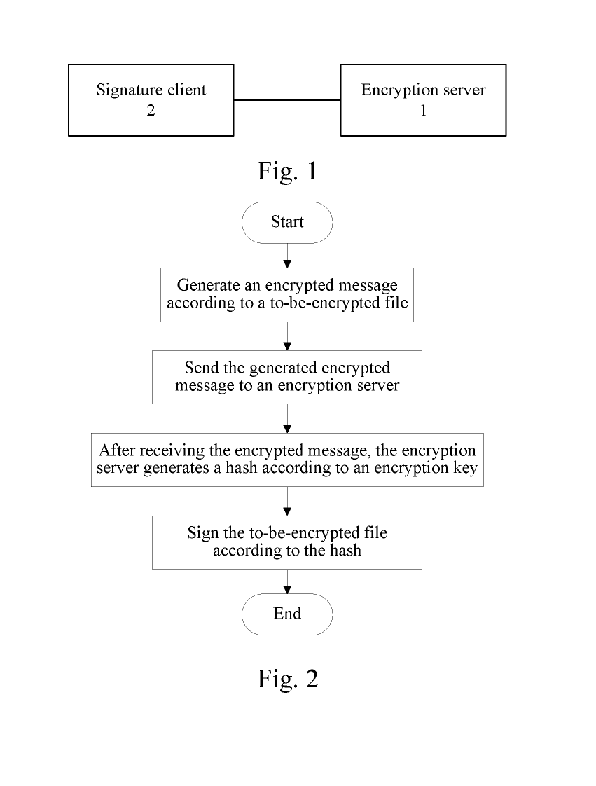

FIG. 2 is a flowchart of a file signature method according to an embodiment of this application. As shown in FIG. 2, according to another aspect of the present disclosure, a file signature method is provided, including:

generating an encrypted message according to a to-be-encrypted file;

sending the generated encrypted message to an encryption server;

after receiving the encrypted message, generating, by the encryption server, a hash according to an encryption key; and

signing the to-be-encrypted file according to the hash.

The foregoing method can be implemented in the file signature system provided in FIG. 1. In an embodiment, the method may further include: compiling the to-be-encrypted file to a binary file, and generating the encrypted message according to the binary file. The method may further include: adding the hash at the end of the to-be-encrypted file, so as to sign the to-be-encrypted file.

According to the file signature method and system provided in the present disclosure, using a specified encryption server to store a key has technical effects of avoiding key exposure and improving signature safety.

Although preferable implementation manners of some embodiments of the present disclosure have been described in detail above with reference to the accompanying drawings, the present disclosure is not limited to specific details in the foregoing implementation manners. Various simple variations can be made to the technical solutions of the present disclosure within the scope of the technical idea of the present disclosure, and such simple variations all fall within the protection scope of the present disclosure.

It should be further noted that the specific technical features described in the foregoing specific implementation manners can be combined in any appropriate manner as long as no conflict occurs. To avoid unnecessary repetition, various possible combination manners will not be described in the present disclosure.

In addition, various different implementation manners of the present disclosure may also be combined arbitrarily. Such combinations shall also be considered as the content disclosed by the present disclosure as long as these combinations do not depart from the concept of the present disclosure.

In an example, an embodiment of the present disclosure further provides a non-volatile computer storage medium, which stores a computer executable instruction, where the computer executable instruction is configured to perform the file signature method in any one of the foregoing method embodiments.

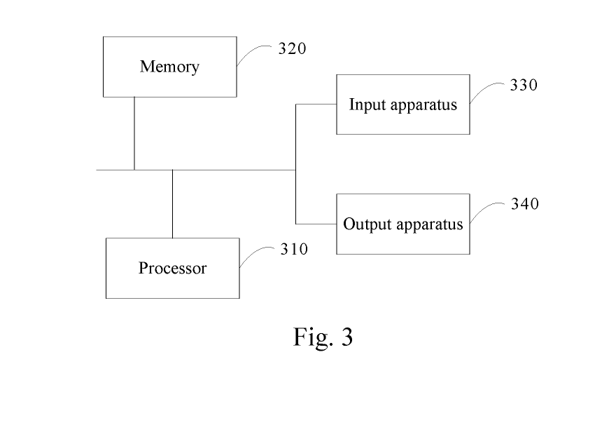

FIG. 3 is a schematic structural diagram of hardware of a device for executing a file signature method according to an embodiment of the present disclosure. As shown in FIG. 3, the electronic device includes:

one or more processors 310 and a memory 320, where only one processor 310 is used as an example in FIG. 3.

The device for executing the file signature method may further include: an input apparatus 330 and an output apparatus 340.

The processor 310, the memory 320, the input apparatus 330, and the output apparatus 340 can be connected by means of a bus or in other manners. A connection by means of a bus is used as an example in FIG. 3.

As a non-volatile computer readable storage medium, the memory 320 can be used to store non-volatile software programs, non-volatile computer executable programs and modules, for example, a program instruction/module corresponding to the file signature method in the embodiments of this application. The processor 310 executes various functional applications and data processing of the server, that is, implements the file signature method of the foregoing method embodiments, by running the non-volatile software programs, instructions, and modules that are stored in the memory 320.

The memory 320 may include a program storage area and a data storage area, where the program storage area may store an operating system and an application that is needed by at least one function; the data storage area may store data created according to use of a signature client, and the like. In addition, the memory 320 may include a high-speed random access memory, or may also include a non-volatile memory such as at least one disk storage device, flash storage device, or another non-volatile solid-state storage device. In some embodiments, the memory 320 optionally includes memories that are remotely disposed with respect to the processor 310, and the remote memories may be connected, via a network, to the signature client. Examples of the foregoing network include but are not limited to: the Internet, an intranet, a local area network, a mobile communications network, or a combination thereof.

The input apparatus 330 can receive entered digits or character information, and generate key signal inputs relevant to user setting and functional control of the signature client. The output apparatus 340 may include a display device, for example, a display screen.

The one or more modules are stored in the memory 320; when the one or more modules are executed by the one or more processors 310, the file signature method in any one of the foregoing method embodiments is executed.

The foregoing product can execute the method provided in the embodiments of this application, and has corresponding functional modules for executing the method and beneficial effects. Refer to the method provided in the embodiments of this application for technical details that are not described in detail in this embodiment.

The electronic device in this embodiment of the present disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this application, rather than limit this application.

Although this application is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this application.

What is claimed is:

1. A file signature system, comprising:
an encryption server, configured to store an encryption key; and
a signature client, configured to: generate an encrypted message according to a to-be-encrypted file, and send the generated encrypted message to the encryption server, wherein
the encryption server is configured to: after receiving the encrypted message, generate a hash according to the encryption key, and send the hash back to the signature client; and
the signature client is configured to sign the to-be-encrypted file according to the hash.

2. The file signature system according to claim 1, wherein the signature client is configured to: compile the to-be-encrypted file to a binary file; and
generate the encrypted message according to the binary file.

3. The file signature system according to claim 2, wherein the encrypted message is a message digest of the binary file.

4. The file signature system according to claim 3, wherein the message digest is MD5 code.

5. The file signature system according to claim 1, wherein the signature client is configured to add the hash at the end of the to-be-encrypted file, so as to sign the to-be-encrypted file.

6. The file signature system according to claim 2, wherein the signature client is configured to add the hash at the end of the to-be-encrypted file, so as to sign the to-be-encrypted file.

7. The file signature system according to claim 3, wherein the signature client is configured to add the hash at the end of the to-be-encrypted file, so as to sign the to-be-encrypted file.

8. The file signature system according to claim 4, wherein the signature client is configured to add the hash at the end of the to-be-encrypted file, so as to sign the to-be-encrypted file.

9. The file signature system according to claim 1, wherein the encryption server is in communication with the signature client through an application programming interface API.

10. The file signature system according to claim 2, wherein the encryption server is in communication with the signature client through an application programming interface API.

11. The file signature system according to claim 3, wherein the encryption server is in communication with the signature client through an application programming interface API.

12. The file signature system according to claim 4, wherein the encryption server is in communication with the signature client through an application programming interface API.

13. The file signature system according to claim 5, wherein the encryption server is in communication with the signature client through an application programming interface API.

14. A file signature method, which is applied to a terminal, comprising:
generating an encrypted message according to a to-be-encrypted file;
sending the generated encrypted message to an encryption server;
after receiving the encrypted message, generating, by the encryption server, a hash according to an encryption key; and
signing the to-be-encrypted file according to the hash.

15. The file signature method according to claim 14, further comprising:
compiling the to-be-encrypted file to a binary file; and
generating the encrypted message according to the binary file.

16. The file signature method according to claim 15, wherein the encrypted message is a message digest of the binary file.

17. The file signature method according to claim 16, wherein the message digest is MD5 code.

18. The file signature method according to claim 14, further comprising:
adding the hash at the end of the to-be-encrypted file, so as to sign the to-be-encrypted file.

19. The file signature method according to claim 15, further comprising:
adding the hash at the end of the to-be-encrypted file, so as to sign the to-be-encrypted file.

20. A non-volatile computer storage medium storing computer executable instructions, wherein the computer executable instructions are configured to:
generate an encrypted message according to a to-be-encrypted file;
send the generated encrypted message to an encryption server;
after receiving the encrypted message, generate, by the encryption server, a hash according to an encryption key; and
sign the to-be-encrypted file according to the hash.
